(19) United States
(12) Patent Application Publication
(10) Pub. No.: US 2009/0133014 A1
(43) Pub. Date: May 21, 2009

(54) METHODS, APPARATUSES AND COMPUTER PROGRAM PRODUCT FOR AUTOMATIC DOWNLOAD OF SOFTWARE DEPENDENCIES ON INSTALLATION

(75) Inventors: JUKKA PAAVO LAURILA, Espoo (FI); Petri Kalevi Laine, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/941,608

(22) Filed: Nov. 16, 2007

(51) Int. Cl. G06F 9/445

(52) U.S. Cl. 717/174

(57) ABSTRACT

A device for automatically downloading an application package is provided. The application package that is downloaded contains a dependency manager, a configuration file and other application files. During installation of the application package the dependency manager is started automatically and is capable of reading data in the configuration file contained within the application package. The dependency manager is further capable of comparing information relating to required components in the file with required components in the device and determining if any required components are missing or whether a newer version of the required components in the device are required. In this regard, the dependency manager is further capable of generating a request for a required component(s) that is missing or is not up-to-date and downloading the missing or outdated required component(s) from a server. The dependency manager is further capable of installing the downloaded required component(s) in the device.

### FIELD OF THE INVENTION

Embodiments of the present invention relate generally to automatic download of required software components upon installation of an application, and more particularly, relate to a method, device, and computer program product for embedding a dependency manager in an application package, so that required software components can be downloaded automatically.

### BACKGROUND OF THE INVENTION

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. Additionally, mobile electronic devices are becoming more complex and are starting to depend more and more on required components such as runtimes and libraries. These required components are also evolving at a rate that is much faster than the upgrade cycle of mobile electronic devices. Currently, mobile software applications are delivered to mobile electronic devices in files known as application installation packages. An application can either contain all components needed to run on any electronic device that it can be installed on, or it can depend on components that are not available in all target electronic devices. In this regard, application packages that are dependent on required components require installation by the mobile electronic device of the required component(s) in order for the application package to operate properly.

Given that required components are evolving faster than outdated mobile electronic devices, it is beneficial for a business to deploy new required components to outdated mobile electronic devices that are already on the market. In order to run software that depends on these required components on as many mobile electronic devices as possible, there must be a way to deliver the required components to the mobile electronic devices that are missing the required components. At present, there are a few choices that developers of application packages may employ to ensure that user's of mobile electronic devices are able to run an application package that they receive in a situation where the application package requires and is dependent on other components (e.g., required components) to run. For instance, today's developers of applications often restrict or limit the electronic devices to only those electronic devices that already have the correct required component for the application installed. However, a drawback to this approach is that the potential users of the application are reduced by those users who posses the latest and most technologically advanced electronic devices. In this regard, the target market for the application is diminished.

Another approach of today's developer is to bundle the required components in the application installation package. However, this approach suffers from the drawback of increasing the size of the application package and also can cause problems if different application bundle include different versions of the required component(s). One other approach of today's developers of application packages consists of requiring a user to install the required component(s) manually. However, manual installation of a required runtime component typically requires a level of technical sophistication from the user and makes installation a more difficult and tedious process. Manual installation of the required component(s) may also result in a higher technical support burden of the developer to provide assistance to users who are manually downloading the required component(s).

In order to provide a solution for the problems described above, it may be advantageous to provide a means for improving the deployment of required components to mobile electronic devices having a particular application package(s).

### BRIEF SUMMARY OF THE INVENTION

The exemplary embodiments of the present invention provide a dependency manager that is embedded in an application package. The dependency manager runs automatically when the application package is installed and it determines if the correct dependencies are present and requests and downloads any missing required components (also referred to herein as dependencies) or outdated required components from a backend server and installs them. With this mechanism, required components may be deployed to any mobile electronic device that is able to run a program automatically upon installation of an application package. Moreover, the developer of the application package does not need to embed the required components in the application package, but can still be sure that the required components are installed during the installation process of the application package.

In one exemplary embodiment, a method and a computer program product for automatically downloading required components are provided. The method and computer program product includes reading a file embodied in an application during installation of the application and comparing information relating to one or more required components in the file with one or more required components installed in a device. The method and computer program product further includes determining if any of the one or more required components in the application are missing or whether a newer version of the one or more required components in the application are required based on the comparison. The method and computer program product further comprises generating a request for at least one required component when the determination reveals that at least one required component, among the one or more required components in the application, is missing or a newer version of the at least one required component is required. The method and computer program product further includes downloading the at least one required component and installing the at least one required component in the device during the installation of the application.

In another exemplary embodiment, an apparatus for automatically downloading required components is provided. The apparatus includes a processing element that is configured to read a file embodied in an application during installation of the application and compare information relating to one or more required components in the file with one or more required components in a device. The processing element is further capable of determining if any of the one or more required components in the application are missing or whether a newer version of the one or more required components in the application are required based on the compared information. The processing element is further configured to generate a request for at least one first required component when the determining reveals that at least one required component, among the one or more required components of the application, is missing or a newer version of the at least one required component is required. The processing element is further configured to download the at least one required component and install the at least one required component in the device during the installation of the application.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communication system according to an exemplary embodiment of the present invention;

FIG. 3 is a schematic block diagram of a backend server according to an exemplary embodiment of the present invention;

FIG. 4A is a diagram of an application installation package according to an exemplary embodiment of the present invention;

FIG. 4B is a diagram of a memory of an electronic device that is capable of storing application packages and required components;

FIG. 5 is a flowchart of a dependency manager for facilitating automatic download of packages containing required components according to an exemplary embodiment of the present invention; and

FIG. 6 is a flowchart for a method of automatically downloading required components upon installation of an application package according to an exemplary embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

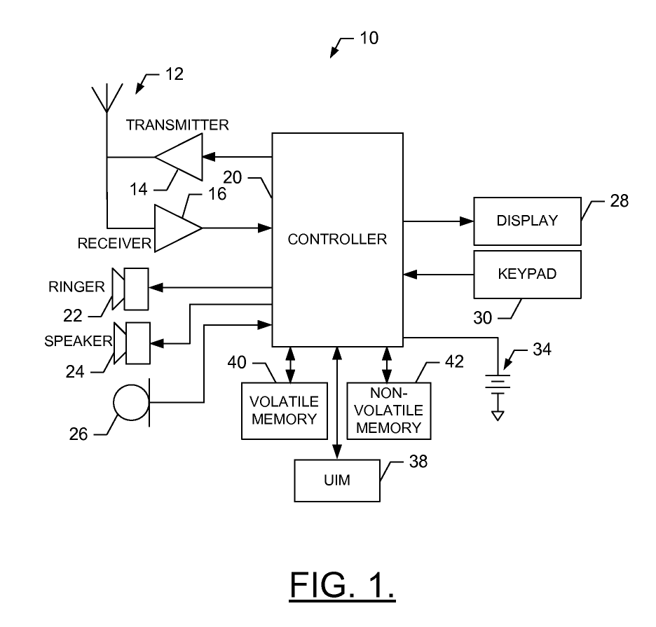

FIG. 1 illustrates a block diagram of a mobile terminal 10 that would benefit from the present invention. It should be understood, however, that a mobile telephone as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDAs), pagers, mobile televisions, laptop computers and other types of voice and text communications systems, can readily employ the present invention.

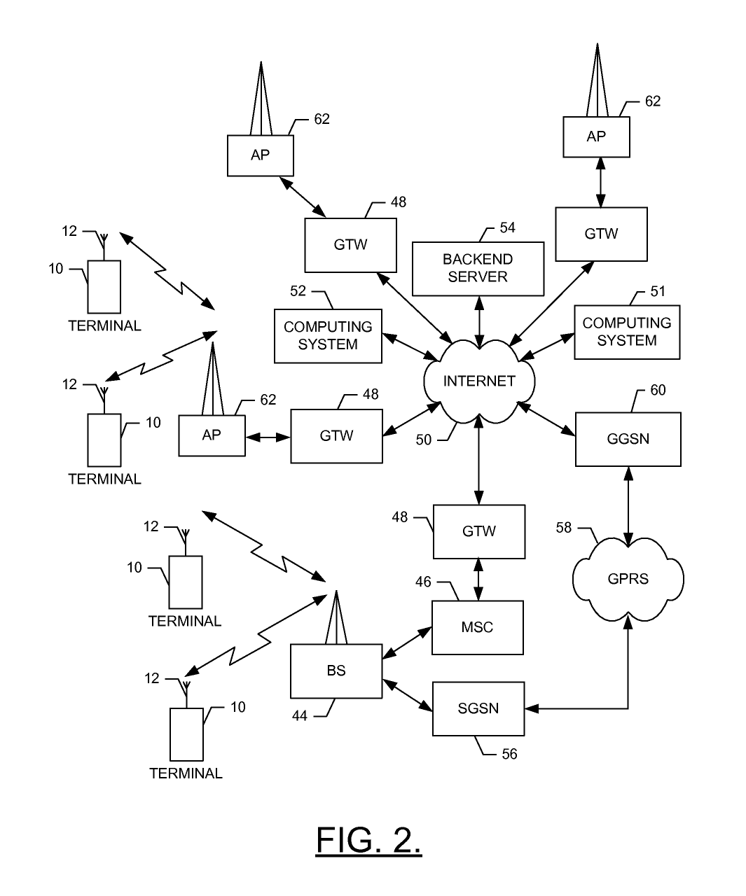

In addition, while several embodiments of the method of the present invention are performed or used by a mobile terminal 10, the method may be employed by other than a mobile terminal. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries. For example, network devices as shown in FIG. 2 and described below, or indeed, any electronic device involving hardware and software elements would similarly benefit from the present invention. Accordingly, the present invention should not be construed as being limited to applications in the mobile communications industry.

The mobile terminal 10 includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to Hypertext Transmission Protocol (HTTP), for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown), one or more menu buttons (not shown) or other input device. In embodiments including the keypad 30, the keypad 30 includes the conventional numeric (0-9) and related keys (#, *), and other keys used for operating the mobile terminal 10. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

Additionally, the non-volatile memory 42 may store one or more application packages 64 and one or more required components 67 that the application packages 64 depend on in order to operate properly. For example, the application package 64 may include but is not limited to a Symbian™ application package which is a program for mobile electronic devices such as Nokia Corporation's S60 smart phones. An application package 64 such as the Symbian™ application package may contain associated application code and data files. The Symbian™ application package may depend on required components such as libraries, runtimes, toolkits and user interface frameworks to operate properly. The application packages 64 and the required components 67 may be pre-loaded in a memory of the mobile terminal 10. Alternatively, one or more of the application packages 64 and required components 67 may be downloaded from a computing system 52 or a server such as backend server 54 in the manner discussed below. As referred to herein the application packages 64 may consist of one or more files that make up software and/or executable code for the operation of corresponding programs on the mobile terminal 10, and/or data files needed by the application. Additionally, as referred to herein required components are any components in computer readable code that an application package depends on in order to operate properly. The required components may consist of any data, but typically they contain executable code. Once a required component(s) is installed in an electronic device, it may be used by other applications which also require the same required component for proper operation of the corresponding application.

Referring now to FIG. 2, an illustration of one type of system that would benefit from the present invention is provided. The system includes a plurality of network devices, any of which may employ embodiments of the present invention. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and the present invention is not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), backend server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or backend server 54 may be coupled to the mobile terminal 10 via the Internet 50, SGSN 56 and GGSN 60. In this regard, devices such as the computing system 52 and/or backend server 54 may communicate with the mobile terminal 10 across the SGSN 56, GPRS core network 58 and the GGSN 60. By directly or indirectly connecting mobile terminals 10 and the other devices (e.g., computing system 52, backend server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, Wireless-Fidelity (Wi-Fi) techniques and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the backend server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 and/or backend server 54 across the Internet 50, the mobile terminal 10, computing system 52 and backend server 54 may be coupled to one another and communicate in accordance with, for example, RF, BT, IrDA or any of a number of different wireline or wireless communication techniques, including LAN, WLAN, WiMAX, Wireless Fidelity (Wi-Fi) and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

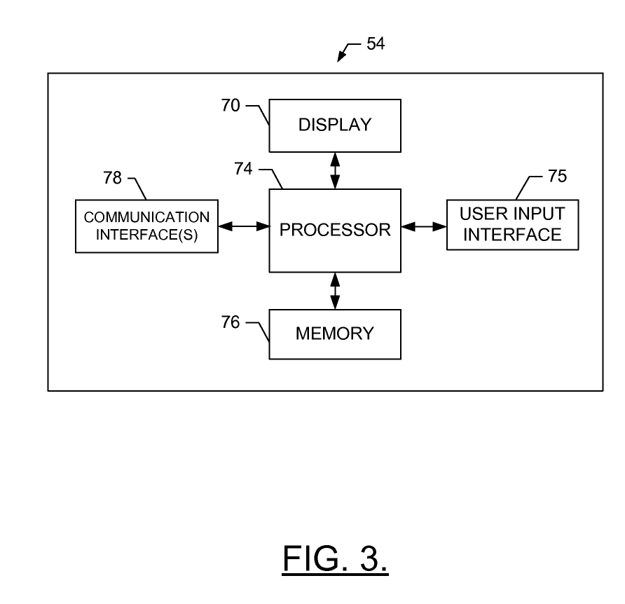

Referring now to FIG. 3, a block diagram of an entity capable of operating as a backend server 54, is shown in accordance with one embodiment of the present invention. The entity capable of operating as a backend server 54 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 3, the entity can include a processor 74 connected to a memory 76. The memory can comprise volatile and/or non-volatile memory, and typically stores content, data or the like. For example, the memory typically stores content transmitted from, and/or received by, the entity. Also, for example, the memory typically stores client applications, instructions or the like for the processor to perform steps associated with operation of the entity in accordance with embodiments of the present invention. In addition, the memory 76 may store application installation packages 64, such as for example, mobile electronic device software applications and configuration files such as, for example, configuration file 69 as well as required components (for example required components 67) including but not limited to libraries consisting of executable software functions, runtimes, (e.g. software implementable in source code) runtime libraries consisting of program libraries that may be used by a controller, such as controller 20, to implement functions in programming language during runtime, data files such as language packs and the like. As explained below, for example, the memory can store client application(s).

As described herein, the client application(s) may each comprise software operated by the respective entities. It should be understood, however, that any one or more of the client applications described herein can alternatively comprise firmware or hardware, without departing from the spirit and scope of the present invention. Generally, then, the backend server 54 can include one or more logic elements for performing various functions of one or more client application(s). As will be appreciated, the logic elements can be embodied in any of a number of different manners. In this regard, the logic elements performing the functions of one or more client applications can be embodied in an integrated circuit assembly including one or more integrated circuits integral or otherwise in communication with a respective network entity (i.e., computing system, backend server, etc.) or more particularly, for example, a processor 74 of the respective network entity.

In addition to the memory 76, the processor 74 can also be connected to at least one interface or other means for displaying, downloading, transmitting and/or receiving data, content or the like. In this regard, the interface(s) includes at least one communication interface 78 or other means for downloading, transmitting and/or receiving data, content or the like. In this regard, the communicating interface 78 is capable of sending an electronic device such as a mobile terminal 10, one or more application installation packages as well as one or more required components. The communication interface(s) can include a first communication interface for connecting to a first network, and a second communication interface for connecting to a second network. In addition to the communication interface(s), the interface(s) can also include at least one user interface that can include one or more earphones and/or speakers, a display 70, and/or a user input interface 75. The user input interface, in turn, can comprise any of a number of devices allowing the entity to transmit and/or receive data to/from a user, such as a microphone, a keypad, a touch display, a joystick, image capture device (e.g., digital camera) or other input device.

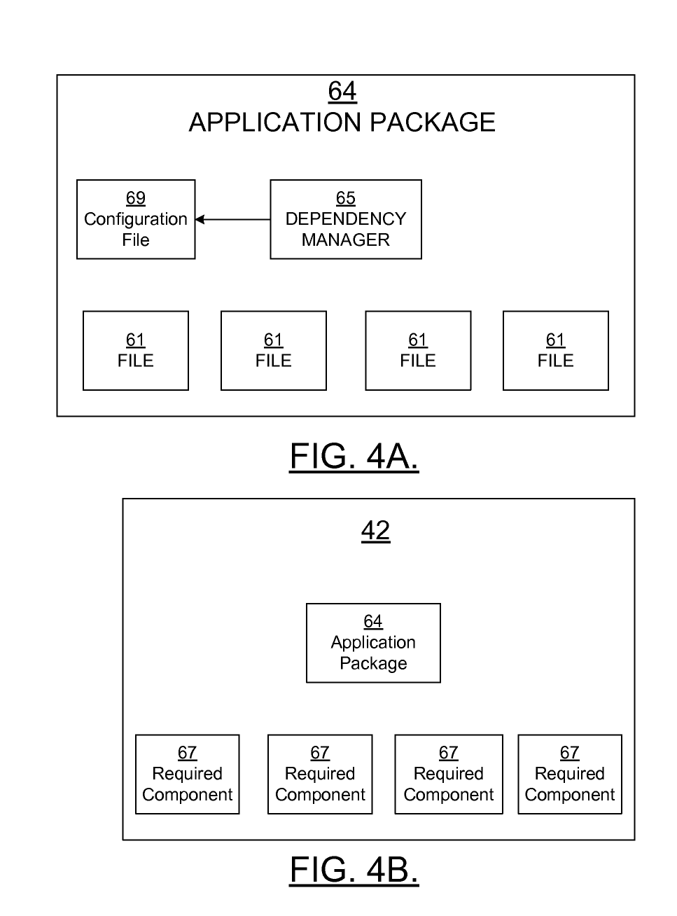

An exemplary embodiment of the invention will now be described with reference to FIG. 4A, in which certain elements of an application package for automatically downloading required components from a backend server are displayed. The application packages 64 may be employed, for example, on the mobile terminal 10 of FIG. 1. For instance, the application packages 64 may be stored in a memory such as for example, the non-volatile memory 42. (See FIG. 4B) However, it should be pointed out that the application package 64 of FIG. 4A may also be employed on a variety of other devices, both mobile and fixed, and therefore embodiments of the present invention should not be limited to application on devices such as the mobile terminal 10 of FIG. 1. For example, the application package 64 may be employed on a personal, desktop or laptop computer, etc. It should be pointed out that the functions of the executable code in the application package 64 may be implemented by the controller 20. While one application package 64 is shown in FIG. 4A for illustration purposes, it should be noted that the mobile terminal 10 may have any number of application packages 64.

The application package 64 may comprise any software, executed by controller 20, and embodied in computer readable code and may comprise one or more files comprising software or executable code for the operation of corresponding applications or programs (e.g., Symbian™, Java™, JavaScript™, Flash™, Python™, etc.) on the mobile terminal 10, or other files the application needs. The application package 64 includes one or more configuration files such as for example configuration file 69. Additionally, the application package 64 includes one or more files 61 which may consist of application code and data files for proper operation of an associated program. While four files 61 are shown in FIG. 4A, it should be pointed out that any suitable number of files may be contained within the application package(s) 64.

As shown in FIG. 4A, the configuration file 69 is included in the application package 64. The configuration file 69 contains data specifying the names and versions of required components that the application needs to operate and a uniform resource locator (URL) of a server such as backend server 54 where the required components 67 can be downloaded. The configuration file 69 also specifies which required components the application package 64 needs, identifies where to locate and obtain the required components, if they are not already installed in an electronic device, such as mobile terminal 10, specifies the approximate size of each of the required components in kilobytes and contains any additional information which may need to be sent to the backend server 54. The dependency manager 65 can be used without making changes in the application code of the application packages.

Referring now to FIG. 4B, a memory 42 of the mobile terminal is shown which is capable of storing the application packages and the required components. It should also be pointed out that the application packages 64 and the required components may be installed in the memory 42 of the mobile terminal or any other suitable memory. The required components 67 may be any software, executed by controller 20, and embodied in computer readable code or any other data that is required by an application package to fully operate properly. The required components 67 include but are not limited to libraries consisting of executable software functions, runtimes, such as for example, software implementable in source code, runtime libraries consisting of program libraries that may be used by the controller 20 to implement functions in a programming language during runtime, toolkits, user interface frameworks and the like. Once the required component(s) is installed on a device such as the mobile terminal 10, all applications subsequently installed on the mobile terminal 10 requiring the same required component can utilize the previously installed required component(s). While four required components 67 are shown in FIG. 4B for illustration purposes, it should be pointed out that any number of required components 67 may be installed in the mobile terminal 10. It should also be pointed out that each of the required components 67 may be different. For example, one of the required components 67 may relate to a runtime (e.g., a runtime application) whereas another required component 67 may relate to a library, so on and so forth.

The dependency manager 65 (also referred to herein as DP) is included in the application package (See FIG. 4A) and may include any means of software (executed by controller 20) capable of reading the configuration file 69 and examining the required components stored in the mobile terminal and determining whether all of the required components are present on the electronic device, such as mobile terminal 10. That is to say, the dependency manager 65 is capable of determining whether all of the required components that are required for the application to operate properly on the mobile terminal are stored in the mobile terminal. The determination regarding whether all of the required components that are required for the application to operate properly are stored in the mobile terminal occurs automatically and begins when the application package 64 is being installed on the mobile terminal 10. The dependency manager 65 is capable of reading the configuration file 69 to determine all of the required components 67 required for the application package 64 to operate properly and compare these required components to those present in the mobile terminal 10. If the dependency manager 65 determines that all of the required components 67 in the configuration file 69 are present in the mobile terminal 10, the dependency manager exits the installation process and the installation of the application package is completed.

On the other hand, if the dependency manager 65 determines that one or more required components, that is identified in the configuration file 69, are missing from the mobile terminal, or if the correct or updated version of the required component(s) is not within the mobile terminal 10, the dependency manager 65 may provide a user of the mobile terminal 10 with a prompt or message that is accessible via one or more menu buttons of the user interface and which may be shown on display 28. This prompt or message may include text which asks the user of the mobile terminal 10 if he/she wishes to download the missing required component(s) or download the correct or most up-to-date version of a required component(s). For example, the prompt or message provided by the dependency manager 65 to the user may include but is not limited to a message such as “Packages X, Y and Z are needed. Download now (total size is approximately 700 kilobytes)?” Any other suitable message relating to an inquiry of whether to download missing required components or download correct or updated required components may be employed by the dependency manager 65. In an alternative exemplary embodiment, the dependency manager 65 may determine whether there is enough space in memory 42 of the mobile terminal 10 and if so automatically download missing required components or correct or updated required components.

If the user does indeed wish to download the missing required component(s) 67, the user may utilize the menu buttons of the user interface to select an option such as “Yes” option. Additionally, the user may utilize the keypad 30 to type and answer to the question such as “Yes” or the user may utilize any other suitable mechanism of indicating a desire to proceed with the download of the required component(s). In this regard, if the user of the mobile terminal answers “Yes” to the inquiry regarding whether he/she wishes to download the missing required component(s) or download the correct version or a more up-to-date version of a required component(s), the dependency manager 65 may generate a request for the missing required component(s) and/or the correct or updated version of the required component(s) which may be sent to the backend server via transmitter 14. For example, the request may be sent from the mobile terminal 10 to the backend server 54 by using the Web browser of mobile terminal 10. In this regard, the request may conform to the hypertext transfer protocol (HTTP) and the request may include relating to the required components needed and any suitable additional information such as, for example, a URL of a server such as backend server 54 which identifies the server (e.g., backend server 54) in which the required components may be obtained and downloaded from. The information relating to the required components may consist of identifiers of the missing required component(s) and/or the correct or updated version of the required component(s).

The processor 74 of the backend server 54 is able to examine its memory 76 and retrieve the missing required component(s) and/or the correct or updated required component that is being requested by the mobile terminal 10. Moreover, backend server 54 is capable of sending the missing required component(s), and/or the correct/updated required component(s) to the mobile terminal 10 via the communication interface 78. For example, when the application package 64 is a Symbian™ application package, and the request sent by the mobile terminal relates to a missing required component for the Symbian™-0 application package, the backend server 54 may send the mobile terminal 10 a missing required component 67 such as a library of the Symbian™ application package. The missing required component 67, in this example, may be in a Symbian™ installation package (SIS). It should be pointed out that the request and the missing and/or correct or updated required component(s) may be communicated between the mobile terminal 10 and the backend server 54 using any suitable techniques such as, for example, RF, BT, IrDA or any of a number of different wireline or wireless communication techniques, including LAN, WLAN, WiMAX, Wireless Fidelity (Wi-Fi) and/or UWB techniques.

Upon receipt of the required component(s) from the backend server 54, the dependency manager 65 installs the required component and the installation process of the application package 64 proceeds until completion. In an instance in which the required component(s) is an updated required component or newer version of the required component, the updated/newer version of the required component overwrites a prior version of a required component. It should be pointed out that arbitrary additional information may be included in the request that is sent to the backend server 54. For instance, the request that is sent from the mobile terminal to the backend server 54 may contain information relating to a request for the latest compatible version of a runtime component, such as, for example, a demand for the latest release in the 1.4.x series, in which instance, the backend server 54 utilizes its processor 74 to retrieve the latest compatible version of the runtime component (in this example the latest release in the 1.4.x series) from memory 76 and send this latest compatible version of the runtime component to the mobile terminal. The request may also include information relating to the device model of the mobile terminal 10 in which case the backend server 54 may utilize its processor 74 to generate a customized package consisting of required components that is tailored for the mobile terminal 10 and which is sent to the mobile terminal 10. Additionally, the request may include information relating to the IMEI code of the mobile terminal 10 in which case the backend server 54 is capable of utilizing its processor 74 to dynamically generate and send to the mobile terminal 10 a package that is locked based on the IMEI code of the device, i.e., mobile terminal 10. Moreover, the request may include information relating to the mobile operator identifier of the mobile terminal 10 in which case the backend server 54 is capable of utilizing the processor 74 to generate an operator-customized version of the application package that is sent to the mobile terminal 10.

The request can also include an identifier for the currently selected language (such as for example English or German) of the mobile terminal 10, in which instance, the backend server 54 may utilize its processor 74 to identify the correct language variant package in memory 76 which is sent to the mobile terminal 10. In this manner, all language variants need not be included within the application package 64. That is to say, since the correct language variant can be provided to the mobile terminal 10 by the backend server 54 all of the language variants do not need to be included within the application package. The language variant packages typically include translations of messages that the application shows to the user for example on display 28. Furthermore, the request may also include information relating to the version of the application package being installed, in which instance, the backend server 54 is capable of utilizing its processor 74 to determine if the application package 64 being installed is the latest version and identifying and sending to the mobile terminal 10 a newer package if the application package 64 is not the newest or latest application package available. In an exemplary alternative embodiment, the application package 64 may not contain an application such as files 61 at all but instead contains the dependency manager 65 and a configuration file 69. The configuration file 69 is this alternative exemplary embodiment contains information relating to an instruction indicating to the dependency manager 65 to always download the latest package from backend server 54 and once downloaded install the latest version of the application package to the mobile terminal 10. In this regard, the backend server 54 determines the latest version of the application package and sends the latest version to the mobile terminal 10. The dependency manager 65 installs this latest version and in this manner the user of the mobile terminal 10 is always capable of obtaining the most current package consisting of all the required components of the application package, even when the application package 64 itself does not contain an application or files 61 making up an application.

The processor 74 of the backend server 54 may use logical functions to determine which required components need to be installed to various mobile terminals. These logical functions may be in the form of instructions and can be changed by a person utilizing the keypad of the user input interface 75 or other input device of the backend server 54 to define new or different logical functions, without having to actually distribute new application packages to the mobile terminals 10. For instance, if an operator or the like determines that a particular application package needs a new or different/updated version of a required component(s), logical functions may be defined at the backend server 54 specifying that during the installation process of the application package and upon receiving a request from the dependency manager 65, the backend server 54 will send the new or different/updated version of the required component(s), that was defined by the logical function(s), to the mobile terminal 10. In this regard, there is no need to change and redistribute application packages if the changes are needed to the required components that the application needs. Moreover, because the dependency manager 65 and the configuration file 69 are embedded within the application package 64, and the dependency manager is able to retrieve required components, there is no change needed in the software, i.e., the computer readable code of the application package(s) 64 itself.

It should also be pointed out that in the event that the mobile terminal does not have a network connection to Internet 50, the dependency manager 65 is capable of notifying the user of the mobile terminal 10, where he/she can download application packages and required components manually. This notification may be in the form of a message that is shown on display 28 and the notification may include a URL relating to a server where the application packages and required components can be downloaded. As such, a user of the mobile terminal 10 can then download the application packages and the required components using a different electronic device, for example a personal computer. The user may then transfer the downloaded application packages and required components to his/her mobile terminal 10 using a radio frequency (RF), Bluetooth (BT), infrared (IrDA), WLAN, Wi-Fi or any of a number of different wireless networking techniques. Alternatively, the user may download the application packages and required components using an electronic device such as a personal computer and store them on a memory card (e.g., microSD (Secure Digital) card) and subsequently transfer the application packages and required components stored on the memory card to the mobile terminal 10.

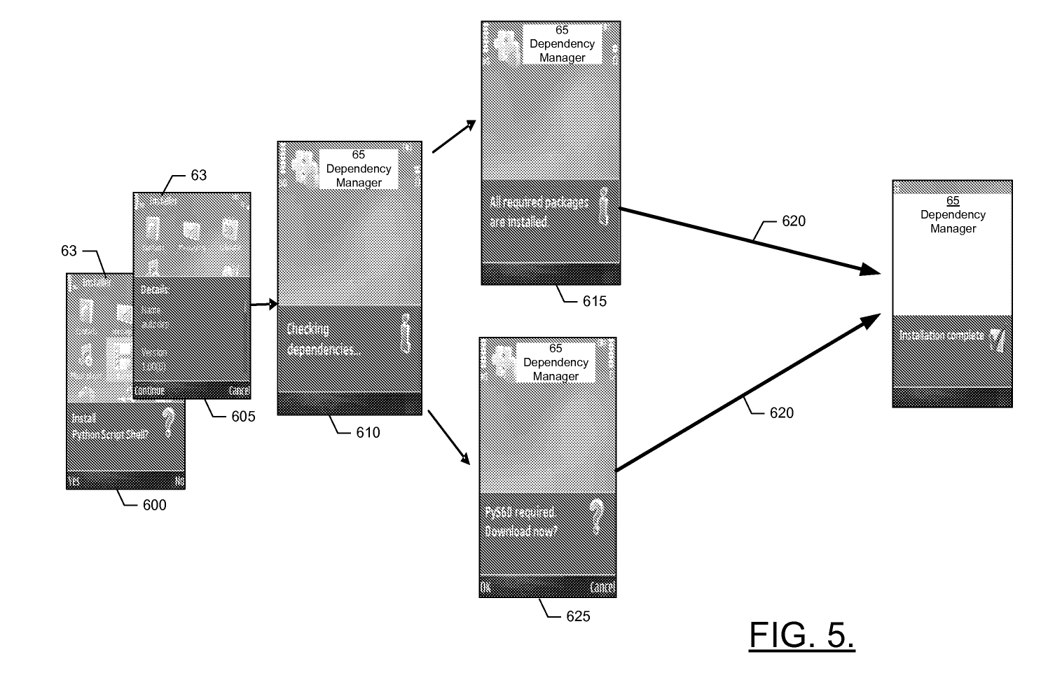

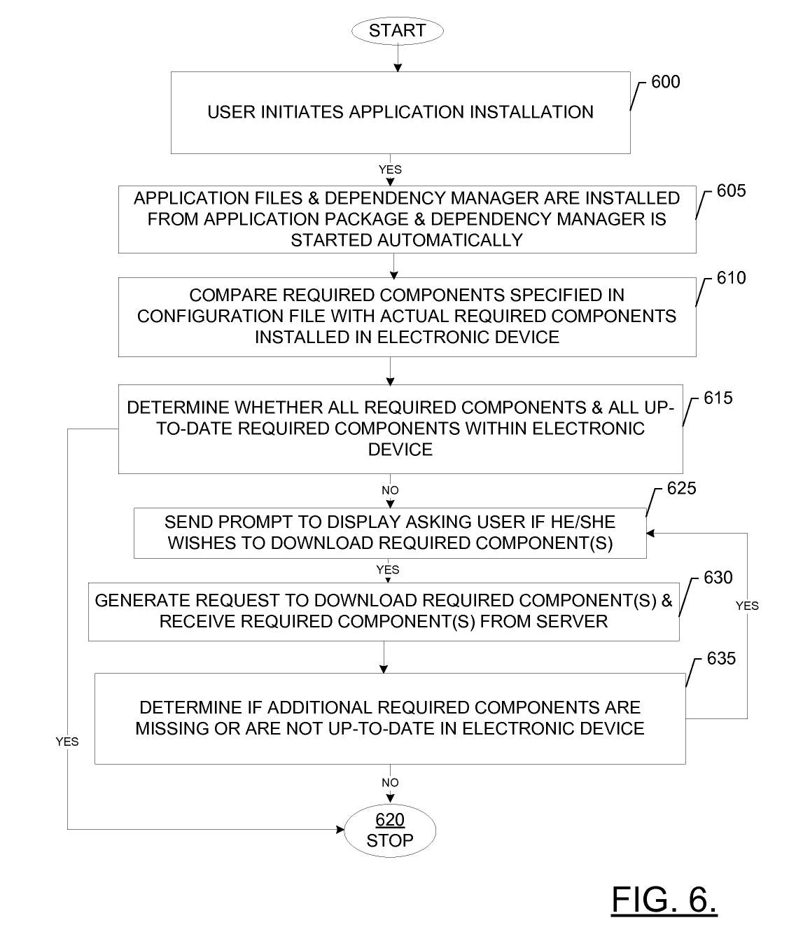

Referring now to FIGS. 5 & 6, flowcharts of a dependency manager for facilitating automatic download of packages containing required components are provided. For proposes of the illustration only and not of limitation, the dependency manager 65 of FIG. 5 is embodied in an application package 64 such as for example Script Shell and the dependency manager 65 is being employed during installation of the Script Shell application. It should be pointed out however, that the dependency manager 65 may be embodied in any suitable application package and operate during the installation of any suitable application package. The user of the mobile terminal 10 initiates an installation process of the Script Shell application by invoking installer 63 and the dependency manager 65 is invoked or launched. Alternatively, one or more files 61 may contain an instruction to install the application package in which case the installer 63 of the operating system on the mobile terminal 10 begins the installation process of the application package and invokes or launches the dependency manager 65. During installation, the user is asked if he/she would like to install the application, e.g., “Script Shell?” (Step 600) If the user selects “Yes” using the keypad 30 of the user interface of the mobile terminal 10 for example, the application files and the dependency manager are installed from the application package and the dependency manager is started automatically. (Step 605) The version of the Script Shell, i.e., Version 1.00(0) is read by the dependency manager 65. The dependency manager 65, reads the configuration file 69 and compares all of the required components 67 for the Script Shell application that are identified within the configuration file 69 to the required components 67 contained within the mobile terminal 10. In this regard, the dependency manager 65 checks whether all of the required and up-to-date required components (i.e., dependencies) are contained within the electronic device such as mobile terminal 10. (Step 610) If the dependency manger 65 determines that all of the required components are within the electronic device, i.e., mobile terminal 10 and that all of the required components are up-to-date, the dependency manager 65 exists the installation process and installation is completed. (Steps 615 and 620)

On the other hand, when the dependency manager 65 determines that some of the required components are missing from the mobile terminal or that a newer version of a required component(s) is required, the dependency manager 65 prompts the user of the mobile terminal 10 that one or more required components are missing from, or not present on the mobile terminal 10 and may send a message to display 28 asking the user, if he/she would like to download the required component(s), in this example the “PyS60” (Step 625) Although not shown in FIGS. 5 & 6, this message may also include the size of the required components that are required for download. For instance, the dependency manager may read in the configuration file that PyS60 is 700 kilobytes and include this information in the message. If the user, selects “OK” to download the required component(s), i.e., the dependency manager 65 generates a request having a URL of a server such as backend server 54 where the required component(s) can be downloaded and the server sends the required component(s), i.e., “PyS60” to the dependency manager 65, according to the mechanism discussed above, and the dependency manager installs this required component(s). (Step 630) (not shown in FIG. 5) If the dependency manger 65 determines that there are more required components relating to the Script Shell application that are missing on the mobile terminal 10 or that the mobile terminal 10 still does not contain the most up-to-date required components for the Script Shell application, the dependency manager sends another message to display 28 asking the user, if he/she would like to download the required component(s). (Step 635) (not shown in FIG. 5) On the contrary, if the dependency manager 65 determines that there are no more required components that are missing from the mobile terminal and that the mobile terminal contains the most up-to-date required components for the Script Shell application, the installation is completed. (Step 620)

The dependency manager 65 and the configuration file 69 embedded within the application package 64 makes it possible to leverage the previously existing electronic devices as application and service platforms so that new runtimes and libraries can be deployed to these electronic devices. In other words, the dependency manager 65 makes it possible to package an application so that it can be installed both to electronic devices that already have the dependencies and to electronic devices that do not have them, without needing any special dependency management support to be present in the target electronic devices beforehand. Usage of the dependency manager 65 and the configuration file 69 embedded within the application package 64 also alleviates the user from having to install the dependencies manually and from having to embed all dependencies in the application package, which would make the application package bigger and introduce problems relating to different versions of the dependencies.

Additionally, as noted above, the logical functions used to determine which required components are installed to which electronic devices can be kept on the backend server, where it can be easily changed without having to distribute new versions of application packages. In an alternative exemplary embodiment, one or more required components 67 may be within the application package 64 and when an installer (e.g., installer 63) of the operating system on the electronic device, e.g., mobile terminal 10, begins the installation process of the application, the dependency manager may install these required components 67 that were in the application package in the mobile terminal 10 instead of downloading the required components for backend server 54.

It should be understood that each block or step of the flowcharts, shown in FIGS. 5 & 6 and combination of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus (e.g., hardware) means for implementing the functions implemented specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the functions specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions that are carried out in the system.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method, comprising:
reading a file embodied in an application during installation of the application;
comparing information relating to a first one or more required components in the file with a second one or more required components in a device;
determining if any of the second required components are missing or whether a different version of the second required components are required based on the comparing;
generating a request for at least one first required component when the determining reveals that at least one required component, among the second required components, is missing or a different version of the at least one required component is required;
downloading the at least one first required component; and
installing the at least one first required component in the device during the installation of the application.

2. The method of claim 1, further comprising prior to the generating, completing the installation of the application when the determination reveals that there are not any missing required components or any different versions of the required components that are required within the second required components.

3. The method of claim 1, further comprising prior to downloading, sending the request to an entity where the at least one first required component is stored.

4. The method of claim 1, wherein the first and second required components comprise at least one of a runtime, library, toolkit or a user interface framework that the application is dependent on to operate properly.

5. The method of claim 1, wherein the file comprises a configuration file which includes data relating a size of the first required components, one or more uniform resource locators (URLs) corresponding to one or more entities storing required components and data relating to one or more names of the first required components and one or more versions of the first required components.

6. The method of claim 3, further comprising using identifiers, corresponding to the at least one first required component, contained in the request to retrieve the at least one first required component.

7. The method of claim 3, further comprising, generating a package which comprises at least one second required component that is tailored for a device based on information relating to the model of the device that is contained within the request.

8. The method of claim 3, further comprising, generating a package which comprises at least one second required component that is locked based on an international mobile equipment identification (IMEI) code of a device that is contained within the request.

9. The method of claim 3, further comprising:
determining if the application being installed is the most current; and
sending a different application if the determination reveals that the application is not the most current based on information relating a version of the application that is included in the request.

10. An apparatus comprising a processing element configured to:
read a file embodied in an application during installation of the application;
compare information relating to a first one or more required components in the file with a second one or more required components in a device;
determine if any of the second required components are missing or whether a different version of the second required components are required based on the compared information;
generate a request for at least one first required component when the determining reveals that at least one required component, among the second required components, is missing or a different version of the at least one required component is required;
download the at least one first required component; and
install the at least one first required component in the device during the installation of the application.

11. The apparatus of claim 10, wherein the processing element is further configured to complete the installation of the application when the determination reveals that there are not any missing required components or any different versions of the required components that are required within the second required components.

12. The apparatus of claim 10, wherein the processing element is further configured to send the request to an entity where the at least one first required component is stored.

13. The apparatus of claim 10, wherein the first and second required components comprise at least one of a runtime, library, toolkit or a user interface framework that the application is dependent on to operate properly.

14. The apparatus of claim 10, wherein the file comprises a configuration file which includes data relating a size of the first required components, one or more uniform resource locators (URLs) corresponding to one or more entities storing required components and data relating to one or more names of the first required components and one or more versions of the first required components.

15. The apparatus of claim 12, wherein the processing element is further configured to insert identifiers, corresponding to the at least one first required component, into the request which are used to retrieve the at least one first required component.

16. The apparatus of claim 12, wherein the processing element is further configured to insert information relating to a model of the apparatus in the request which is used to generate a package which comprises at least one second required component that is tailored for the apparatus.

17. The apparatus of claim 12, wherein the processing element is further configured to insert an international mobile equipment identification (IMEI) code of the apparatus in the request, the IMEI code is used to generate a package which comprises at least one second required component that is locked based on the IMEI code of the apparatus.

18. The apparatus of claim 12, wherein the processing element is further configured to:
insert information relating to a version of the application in the request, the information is used to determine if the application being installed is the most current; and
receive a different application if the determination reveals that the application is not the most current based on the information.

19. A computer program product, the computer program product comprising at least one computer-readable storage medium having computer-readable program code portions stored therein, the computer-readable code portions comprising:
a first executable portion for reading a file embodied in an application during installation of the application;
a second executable portion for comparing information relating to a first one or more required components in the file with a second one or more required components in a device;
a third executable portion for determining if any of the second required components are missing or whether a different version of the second required components are required based on the comparing;
a fourth executable portion for generating a request for at least one first required component when the determining reveals that at least one required component, among the second required components, is missing or a different version of the at least one required component is required;
a fifth executable portion for downloading the at least one first required component; and
a sixth executable portion for installing the at least one first required component in the device.

20. The computer program product of claim 19, further comprising, a seventh executable portion for completing the installation of the application when the determination reveals that there are not any missing required components or any different versions of the required components that are required within the second required components.

21. The computer program product of claim 19, further comprising, a seventh executable portion for sending the request to an entity where the at least one first required component is stored.

22. The computer program product of claim 19, wherein the first and second required components comprise at least one of a runtime, library, toolkit or a user interface framework that the application is dependent on to operate properly.

23. The computer program product of claim 19, wherein the file comprises a configuration file which includes data relating a size of the first required components, one or more uniform resource locators (URLs) corresponding to one or more entities storing required components and data relating to one or more names of the first required components and one or more versions of the first required components.

24. The computer program product of claim 21, further comprising an eighth executable portion for using identifiers, corresponding to the at least one first required component, contained in the request to retrieve the at least one first required component.

25. The computer program product of claim 21, further comprising, an eighth executable portion for generating a package which comprises at least one second required component that is tailored for a device based on information relating to the model of the device that is contained within the request.
